(19) United States
(12) Patent Application Publication
(10) Pub. No.: US 2004/0044571 A1
(43) Pub. Date: Mar. 4, 2004

(54) Method and system for providing advertising listing variance in distribution feeds over the internet to maximize revenue to the advertising distributor

(76) Inventors: Eric Robert Bronnimann, Astoria, NY (US); Jacob Paul Ewerdt, Lakewood, CO (US); William C. Day, Haworth, NJ (US); Kevin RJB. Donovan, White Plains, NY (US); Brian Hammond, New York, NY (US); Ron McCoy, Doraville, GA (US); Christopher Joseph Murphy, Lagrangeville, NY (US); James Keith Toothman, Ringwood, NJ (US); Wen-Wei Wang, Scarsdale, NY (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/378,654

(22) Filed: Mar. 5, 2003

Related U.S. Application Data
(60) Provisional application No. 60/406,064, filed on Aug. 27, 2002.

(51) Int. Cl. G06F 17/60

(52) U.S. Cl. 705/14

(57) ABSTRACT

An Internet advertisement listings provider that distributes advertisements in a bid-for-placement arrangement based on the revenue-efficiency of the advertisements from the bidding advertisers that calculates the revenue to the advertising distribution system by multiplying the click-through rate times the bid amount for each click-through. Advertisers may be allowed to provide multiple advertisements to enable the advertisement listings provider to select from those various advertisements for inclusion in ranked listings based on a determined efficiency among the advertisements. The system also determines the most efficient grouping of advertisements for a limited-space output, comparing groupings of advertisements to other groups to determine the greater revenue to the distribution system.

### RELATED APPLICATIONS

This application claims priority to a provisional patent application, U.S. Patent Application No. 60/406,064, filed Aug. 27, 2002, entitled “Method and System for Providing Advertising Listing Variance in Distribution Fees over the Internet,” still pending.

### FIELD OF THE INVENTION

This invention relates to systems for and methods of varying provided advertisements to increase effectiveness and revenues derived from the advertisements when delivered through distribution channels over the Internet.

### BACKGROUND OF THE INVENTION

Targeted advertising has long been a goal of the companies who place and pay for advertisements. Advertisements can be expensive in any medium. Thus, companies generally would like to pay only for advertisements that will be viewed by a group of individuals likely to be interested in that company's goods or services.

Over the Internet, one form of advertisement is a bid for placement of an on-line advertisement in either search engines or content pages. For example, advertisers may bid an amount of money to be paid for any “click-through” resulting from the placement of an advertised web page/site in results of a search engine associated with a keyword with which the bid and advertisement are associated. Also, advertisers may bid an amount of money to be paid for any “click-through” resulting from the placement of an advertised web page/site in a sponsored links portion of a content-based web page or other sections of a content portal. In such systems, several advertisers may bid against each other for placement of an advertisement in a prioritized listing or display of advertisements, with the highest bidder given priority over other bidders. For example, in the bid-for-placement search engine system, if a consumer searched a paid listing search engine for “airline tickets,” a list of advertisements may be generated with corresponding URL listings so that the consumer can click on the URL listing and go to the website corresponding to that URL listing. Each of the advertisers that provided bids and associated advertisements for the key word “airline tickets” pays the search engine their bid (e.g., a certain amount of money) for every “click-through” to the company's website. Higher or more prominent placement of the advertisement on the list of search results generally leads to more click-throughs for that advertisement and thus, more traffic to the advertiser's target web site. In the system described above, the highest bid for a keyword or content portal is listed first and other bidder's advertisements are listed in descending order based on bid amount. Accordingly, as the cost per click-through (e.g., bid) for the advertising company increases, the closer that company's listing is to the top of the list of search results.

There are drawbacks with such systems. By basing the order of listing of advertisements solely on the amount bid for a keyword or on a content page, less relevant advertisements may be listed at the top of search engine results if the less relevant advertiser is willing to bid whatever is necessary to become the top bidder. When that occurs, viewers of the advertisement become less likely to click through to less-relevant advertisements. For example, on the keyword “airline tickets,” a credit card company may be willing to bid $0.50 per click-through even though credit cards are not very relevant to persons searching for websites related to airline tickets. Accordingly, advertisers that are willing to bid large amounts for click-throughs may still suffer from a low click-through rate. Moreover, in such systems, the advertisement distribution system may only be paid for click-throughs provided for the advertiser. When users are not “clicking-through,” the advertisement distribution system suffers because it only gets paid for click-throughs. Low click-through rates lead to low revenues for the advertising distribution system. Other drawbacks exist with current systems.

### SUMMARY OF THE INVENTION

Various embodiments of the present invention relate to systems and methods that use revenue performance to the advertisement listings provider to monitor and vary rankings of advertisements distributed by the advertisement distribution system. According to one embodiment, an Internet advertisement listings provider may distribute advertisement listings through search engine listings and through ranked listings within an Internet content portal, its associated pages and through affiliated distribution partners. In this embodiment, the order of listing may be based on a rank assigned by the advertisement listings provider. Prior systems ranked advertisements based solely on the amount the advertiser bid on a keyword within the search engine or on a subject matter within a content-based Internet site. Embodiments of the present invention provide improvements on that pure bid method of ranking and placement. According to these embodiments, advertisements may be generated and ranked based on a revenue efficiency model, explained below. Moreover, advertisers may be allowed to provide multiple advertisements to enable the advertisement listings provider to select from those various advertisements for inclusion in ranked listings based on a determined efficiency among the advertisements.

According to yet another embodiment, the system analyzes ranked listings in a grouping, such as a grouping based on the targeted output format. For example, if five listings are to be output for a keyword to a search engine system, then the system analyzes the optimized revenue efficiency for five advertisements in that grouping. Or, in a content portal page, if there are five slots for advertisements in that portal page, then the system analyzes various groupings of advertisements to fill those five slots to determine which groupings in those five slots generates the most revenue per impression. This enhanced embodiment recognizes that diversity, for example, within a limited number of slots may realize the most revenue per impression for some advertising venues. For example, for a content portal page about video games, the most revenue per impression may be generated when the five listings include at least one listing of an advertiser for each of the five different video game platforms, rather than having all five advertisers list advertisements for a single video game platform. The system may also analyze competing advertisers and multiple advertisements from a single advertiser to derive the most efficient revenue per impression for the grouping. These embodiments are described in greater detail below.

In general, however, Internet users have usage habits that often lead them to visit given sites on a frequent and consistent basis. During these visits, the paid listings displayed may not change from prior visits. Based on conventional marketing theory and studies, the incremental value of repeating a given advertising message decreases after a certain number of deliveries to a consumer. Therefore, in a pure bid-based ranking system where revenue is derived by the advertisement distribution system only upon a click-through, after a while, regardless of the bid, an advertisement becomes “stale,” leading to reduced revenue to the distribution system and fewer viewers to the advertiser's web site.

Embodiments of the present invention provide a system and method that monitors click-through rates and revenue generation to determine advertisement and advertiser effectiveness. An objective methodology is implemented to measure advertising listing relevancy to given search terms and content pages as well as a method of maximizing overall advertising effectiveness.

According to one embodiment, an individual advertiser may be permitted to supply multiple advertisements corresponding to a single keyword bid within a pay-for-placement search engine or multiple advertisements corresponding to a single bid within a content-based Internet site distribution system. Each advertisement may be implemented for a given period of time. Click-through rates may then be tracked to determine which advertisement generates the most click-throughs for the advertiser and thus, the most revenue for the advertisement distribution system. The periods of time may be varied as well to determine whether the advertisement is most effective for different time periods, distribution channels, venues, demographic groups, etc. For example, for a company that has two advertisements corresponding to a bid on a single keyword, it may be that one ad receives more click-throughs in the morning and the second ad receives more click-throughs in the evening. The advertisement distributed by the advertisement distribution channel may then be based on the most-efficient ad given all of the possible variables being monitored by the system, including, for example, time, target location and many other variables.

Additionally, advertisers may provide multiple titles and descriptions for their advertising listings to automate this optimization. This ability to provide multiple titles and descriptions for each listing provides further advantages in this automated system of providing maximum relevancy and effectiveness of advertising listings.

According to another embodiment, the advertisement distribution system may generate rankings among competing advertisers/bidders based on a revenue efficiency model. For example, if there were three advertisers on a single keyword in a ranked search engine system bidding $0.25 (Advertiser A), $0.20 (Advertiser B) and $0.15 (Advertiser C) respectively, but generating 10%, 20% and 15% click-through rates, respectively, the engine would output the advertisement provided by the advertiser not in bid order, but based on revenue efficiency. In that example, the order would be Advertiser B ($40.00 per 1000 impressions), Advertiser A ($25.00 per 1000 impressions), and Advertiser C ($22.50 per 1000 impressions). As a result of using revenue efficiency, the advertisement distribution system rewards advertisers for having relevant advertisements while at the same time increasing its own revenues by placing higher revenue-producing advertisements higher in the rankings, thus likely leading to even more revenue. Further, it provides an opportunity for an extremely relevant advertisement to appear within higher rankings even if that advertiser's ability to bid higher amounts are limited.

Additionally, it provides an incentive for advertisers to update their advertisements to keep them “fresh.” This is particularly useful for advertisement distribution through a content portal when users frequent the same pages and content. By incentivizing advertisers in that format to provide alternative ads to be used to keep their ranking high, the advertisement distribution system may be able to keep its revenues from falling as might otherwise occur from decreasing click-through rates when end users of the portal page see the same ads over and over again with each visit to that portal page.

To enable this methodology to be implemented, one embodiment of the present invention provides a system that tracks effective click-through rates for advertiser listings in real time via a Click-Through-Rate Calculator. The Click-Through-Rate Calculator may comprise a system for tracking impressions and clicks over periods of time and that may take Definable Actions that affect feed variance based on changes in those rates. The Click-Through-Rate Calculator may be fed impression data from the Distribution system, may receive Click data from the Click Cache and may have current bid prices for each listing. The Click-Through-Rate Calculator may have data to determine individual and aggregate advertising listing effectiveness on individual feeds. The period of time where the Click-Through-Rate Calculator actually acts on changes in rates and applies variance to given distribution feeds may be called the Decision Period.

The Definable Actions that the Click-Through-Rate Calculator may take for a given search or content distribution feed may comprise one of more of the following: Rotate New Advertising Creative, Remove Advertising Listing, Move Advertising Listing Up, Move Advertising Listing Down, and Add Advertising Listing. Multiple Definable Actions can happen in each Decision Period of the Click-Through-Rate Calculator. Definable Actions and their given thresholds may also be specific to each search and content feed distribution (i.e., the targeted output location for the advertisement).

The Rotate New Advertising Creative action may be triggered by a change in Click-Through-Rate indicating that a given advertising listing is becoming less effective in its current placement. This action may be triggered for advertising listings that have multiple advertising listing creative (Title/Listing) supplied for them.

The Remove Advertising Listing action may be trigged by a change in Click-Through-Rate that indicates that the listing has low effectiveness in a particular feed. This action may comprise the step of notifying the advertiser of the reason of the removal to provide them with the opportunity to update their creative. Removal may also indicate that the advertising listing as judged by the viewers of the listing is irrelevant to the topic matter to which it is currently associated.

The Move Advertising Listing Up action may be trigged by a change in Click-Through-Rate that indicates that the listing has a high degree of effectiveness in a particular feed (i.e., output channel or venue). This action may further maximize Click-Through-Rate by increasing the prominence of placement of that listing. A high Click-Through-Rate generally indicates that a given advertiser listing is “on topic” for or highly relevant to users of that feed and thus a higher or more prominent placement may provide additional value to viewers of that listing. Higher or more prominent placement leads generally to even more click-throughs and thus more revenue to the advertising listings provider.

The Move Advertising Listing Down action may be trigged by a change in Click-Through-Rate that indicates that the listing has a lessening degree of effectiveness in a particular feed over a particular time period. This action may attempt to stabilize overall Click-Through-Rate on that feed (e.g., the total click through rate for grouping) by increasing the prominence of other listings that might have higher Click-Through-Rates in that position. A decreasing Click-Through-Rate may indicate that a given advertiser listing has reached its maximum effective number of views on that topic for that feed.

The Add Advertising Listing action may be trigged by an overall decrease in Click-Through-Rate rates for the entire listing set for that search term or content node. This action may attempt to increase Click-Through-Rate for a grouping by adding a new listing to the current set to provide a new listing with new creative in the feed. In many instances this added listing may be of the same yield as existing listings in the feed but may be more recently added to or updated in the advertising database. For example, business rules may allow higher sorting precedence to advertiser listings that are older than those of the same value. This, and other, definable actions may allow the Click-Through-Rate to also be a factor in determining listing order.

Other objects and advantages of the present invention will be apparent to one of ordinary skill in the art upon review of the descriptions and drawings provided.

### BRIEF DESCRIPTION OF THE DRAWINGS

FIG. 1 depicts a system for distribution of advertisements based on an optimized efficiency-based ranking methodology for a bid-based advertisement system according to an embodiment of the present invention.

FIG. 2 depicts an advertiser listings provider system and database for use in the system of FIG. 1 according to an embodiment of the present invention.

FIG. 3 depicts a graphical user interface for use in enabling a user to create an account with an advertiser listings provider system as part of a process of providing an advertisement for distribution through Internet channels according to an embodiment of the present invention.

FIGS. 4(a)-(b) depict a graphical user interface for use with listing one or more bid-based advertisements for use in a ranked placement keyword output system according to an embodiment of the present invention.

FIG. 5 depicts a graphical user interface for use in confirming one or more advertisement listings made by an advertiser according to an embodiment of the present invention.

FIG. 6 depicts a graphical user interface for enabling an advertiser to place a content-based advertisement in a ranked placement system wherein the content-based system provides for advertising at different levels of granularity including category level, channel level and document level according to an embodiment of the present invention.

FIG. 7 depicts a graphical user interface for enabling selection of a subject level for placement of an advertisement according to an embodiment of the present invention.

FIG. 8 depicts a graphical user interface for enabling selection of a document level for placement of an advertisement according to an embodiment of the present invention.

FIG. 9 depicts a graphical user interface for enabling an advertiser to confirm the categories in which the advertisement is to be placed according to an embodiment of the present invention.

FIGS. 10(a)-(b) depict graphical user interfaces for enabling an advertiser to provide one or more advertisements associated with a content-based advertisement bid in a ranked advertisement distribution system according to an embodiment of the present invention.

FIG. 11 depicts a graphical user interface for enabling the confirmation of advertisement listings for listings made on category level advertisements according to an embodiment of the present invention.

FIG. 12 depicts a graphical user interface for enabling an advertiser to provide contact information step of listing an advertisement on level nodes according to an embodiment of the present invention.

FIG. 13 depicts a graphical user interface for enabling an advertiser to provide billing information as a step of listing an advertisement on level nodes according to an embodiment of the present invention.

FIG. 14 depicts a graphical user interface for enabling an advertiser to confirm and review an account summary to list an advertisement on level nodes according to an embodiment of the present invention.

FIG. 15 depicts a schematic diagram representing a system whereby an advertiser may list advertisements within a structure of subject matter specific nodes according to an embodiment of the present invention.

FIG. 16 depicts a table providing an example of data collected during an evaluation of rankings of advertisements for a specified keyword within a keyword-based advertisement distribution system according to an embodiment of the present invention.

FIG. 17 depicts a table providing an example of data collected and generated during an evaluation of rankings of a plurality of advertisements with a keyword and content-based advertisement context according to an embodiment of the present invention.

FIG. 18 depicts an exemplary content distribution page wherein advertisements are distributed in ranked order for the page based on an efficiency-based ranking system.

FIG. 19 depicts a table providing an example of data collected and evaluated for a plurality of advertisements by a single advertiser over various time periods to determine the optimal advertisement for the advertiser at various times according to an embodiment of the present invention.

### DETAILED DESCRIPTION OF THE PREFERRED EMBODIMENTS

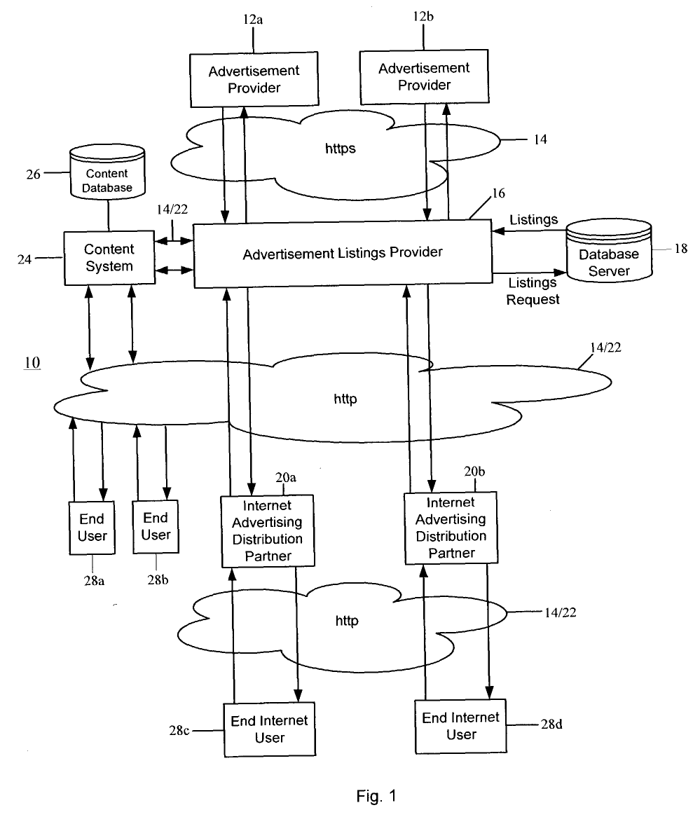

According to one embodiment of the present invention, systems and methods are provided for generating ranked advertisements based on revenue efficiency over given periods of time. An embodiment of a networked environment 10 in which such a system may operate is depicted in FIG. 1. In such a system, advertisement providers 12 connect over a network 14 to an Advertisement Listings Provider 16 (e.g., using a secure https connection) to register, provide payment information, bids and associated advertisements (also called creatives) associated with the bid. For example, the advertisers may provide its bid in association with a keyword for use in a search engine system and may also provide a bid in association with content on a content portal. The Advertisement Listings Provider 16 then stores the information on a database server 18 for later transmittal. The Advertisement Listings Provider 16 may then distribute the listings through various forums or feeds, including providing the listings on one or more web sites affiliated with the Advertisement Listings Provider, through Internet Advertising Distribution Partners 20 (connected over network 14 or 22 depending on security desired), through Content Systems 24 (with associated content databases 26) and through Search Engine systems operated by the Advertisement Listing Provider or Internet Advertising Distribution Partner(s). Through these various forums, the advertisements provided by the advertisement provider may be included in pages displayed to end users 28 (often called an impression). In one embodiment, the advertisement provider 12 is only obligated to pay for the impression if the end user clicks-through the advertisement to the web page target provided by the advertisement provider in affiliation with the particular ad. In addition, the Advertisement Listings Provider 16 may only be paid when a click-through occurs. Also, traditionally, the Advertisement Listing Provider 16 and Internet Distribution Partner(s) 20 may agree to share the revenue for the click-throughs generated through distribution via the Internet Distribution Partner 20.

Each of Advertising Listings Provider 16 and Advertisement Provider 12 may comprise computerized systems that include one or more of the following systems: a web server, a database server, proxy server, network balancing mechanisms and systems, and various software components that enable the system to operate on the Internet or other network type system. Additionally, networks 14 and 22, although depicted as http networks, may comprise other networks such as private lines, intranets, or any other network. Preferably, the connection between advertising provider 12 and advertisement listing provider 16 may comprise secure network connections to insure that data is not subject to attack or corruption by any hacker or other third party. In addition, whereas two advertisement providers are depicted, it should be appreciated that one or more advertisement providers 12 may be provided in the network. Similarly, although one database server 18 is depicted, it should be appreciated that multiple database servers may be provided and that such database servers may be connected to the advertisement listing provider via any type of network connection, including a distributed database server architecture. Similarly, content system 24 and content database 26 may comprise any number of such systems connected to the advertisement provider or advertisement listing provider 16 via any type of network, including an http or https network. Content provider 24 may comprise a system such as advertisement listing provider 16 that provides functionality for enabling connection over the Internet or other network protocols. End users 28 may comprise any user connected to the Internet and may comprise computerized systems that enable that connection through any of various types of networks, including through Internet service providers, cable companies, and any other method of accessing data on the Internet. Internet advertising distribution partners 20 may comprise any system that distributes Internet based advertising to end users. Whereas two Internet advertising distribution partners 20 are depicted, any number may actually be provided.

In general, in these embodiments, the Advertisement Listing Provider 16 generates revenue when end users click-through to advertisements provided by its bidding advertisement providers. The Advertisement Listing Provider 16 may also incur costs for every impression that it reaches in the form of overhead in running a web site or distribution agreements for distribution. Accordingly, the various embodiments of the present invention recognize that in such systems, it is revenue efficiency (click-throughs per impression) that generally produces the Advertisement Listing Provider's profits. By using revenue efficiency to rank advertisements then, the Advertisement Listing Provider's rankings track its own profitability. This is particularly true for distribution channels with limited numbers of slots for advertisements. For example, the assignee of the present invention operates an enterprise known as Sprinks that distributes advertisements through another enterprise known as About.com. Within each web page offered on About.com, About.com has allocated space for five advertisements from Sprinks that are provided by bid-based advertisers that use the Sprinks system. With only five spaces for advertisements, it is in Sprinks' interest to ensure that each of those five advertisements is effective.

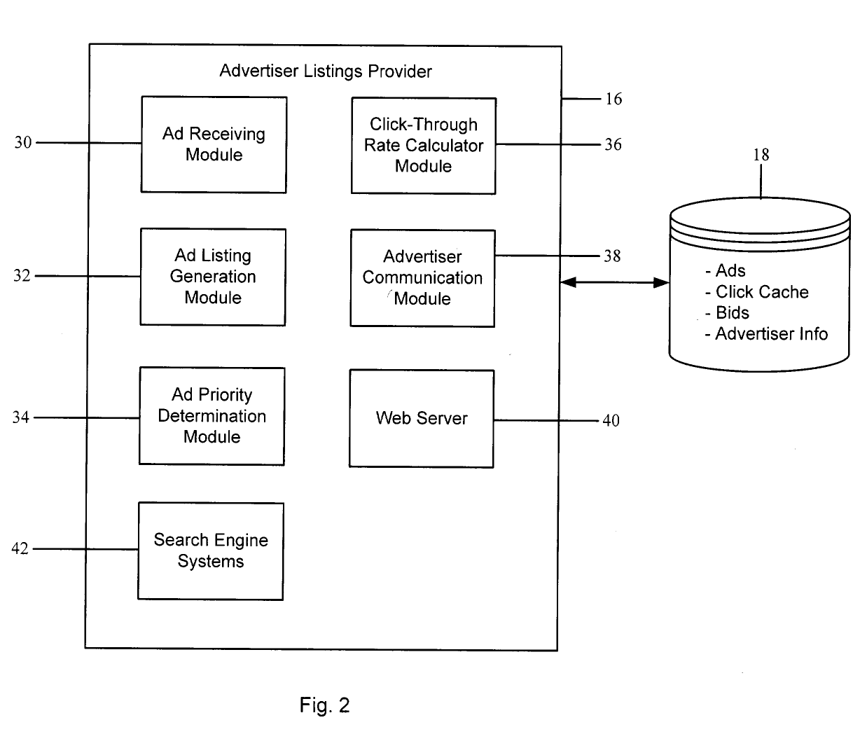

As shown in FIG. 2, the Advertising Listing Provider 16 may comprise a system that provides an advertisement receiving module 30 for interacting with advertising providers to receive advertisement information. It may also comprise an advertising listing generation module 32 that generates a listing of advertisements from the database based on criteria provided and depending on the forum for the advertisements (e.g., search engine, content portal, distribution partner, etc.). An advertising priority determination module 34 may generate an order to the listing based on rankings based on a model. In one embodiment, the advertising priority determination module 34 may determine rankings based on revenue efficiency and utilize a click-through-rate determination module (also called a Click-Through-Rate Calculator). The resulting advertisements generated and ranked may then be communicated through various channels. An advertiser communication module 38 may also be provided for communicating with the advertisers. For example, it may be desired for the system to alert an advertiser prior to changing the advertisement used for a given bid or before moving the advertisement down or up in the rankings. A database 18 may be provided in affiliation with the advertiser listing provider to store advertisements, bids, advertising information and a cache of clicks to be used to determine the click-through-rate.

Additionally, because Advertising Listings Provider 16 may provide the functionality of distributing advertising itself and providing search engine results, web server system 40 may be provided as well as a search engine system 42. It should be appreciated that multiple such systems may be encompassed within the advertising listing provider system 16.

Additionally, database server system 18 may comprise one or more database systems that store various types of data including one or more of the following: advertisements, the click cache, bid amount information, and advertiser information including registration information about the advertisers, accounts for the advertisers, payment information and other information as described herein. Numerous modules may not be provided in various embodiments and/or the modules may be combined together to provide the functionality described. Further, the modules may be dispersed across multiple physical systems or may be duplicated across multiple systems.

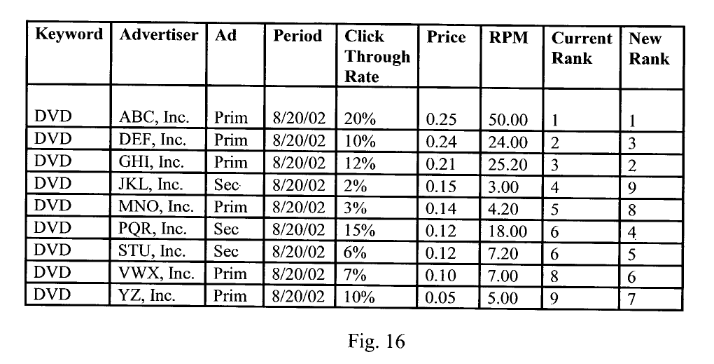

FIGS. 16-19 illustrate various examples of the way in which the Advertising Listing Provider system may implement the revenue efficiency ranking methodology. As shown in FIG. 16, for a given keyword, the advertiser listing provider may have many different advertisers that have bid on that keyword for placement in search results from a search engine implementing a bid-for-placement system. Over a period of time or number of impressions, the advertising listing provider system may monitor and store click-through rates for the effective advertisement for a given advertiser. For example, for every 1000 impressions, it may be determined that the primary advertisement provided by higher bidder on the keyword “DVD” generated a 20% click-through rate. Based on its bid of $0.25 per click-through, that rate generated a revenue per thousand (RPM) of $50.00. Similar data may be tracked for other advertisers that bid on the keyword DVD, including advertisers whose secondary advertisement were already implemented to increase efficiency such as the advertiser JKL, Inc. in FIG. 16.

After determining the RPM for each advertiser, the advertiser listing provider may then take an action, including re-ranking the advertisers for the keyword DVD based on RPM. In this example, several lower bidders may be moved up in the rankings because of their relatively high click-through-rate, indicating the relevancy of their bids. Thus, the system monitors and changes the rankings of advertisements for a given keyword based on RPM. This monitoring and reevaluation of rankings may be ongoing and using different periods of time. For example, click-through rates may be monitored hourly, weekly, monthly, etc.

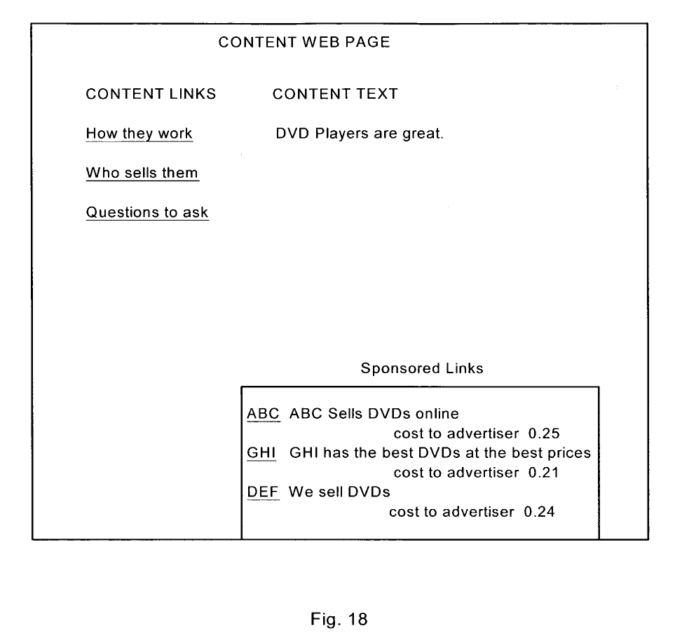

Taking this example, rankings may also be determined by the system for placement in content portals. For example, instead of bidding on the keyword “DVD,” the advertisers may be bidding on a page within a content portal about DVDs. In such a system, a limited number of advertisers may be displayed within that page, as shown, for example, in FIG. 18. Based on the new rankings, then the order or placement of the advertisements in the page may be ABC, GHI and then DEF due to the RPM rates of those three advertisements even though ranking by the bid amounts would have yielded a different result.

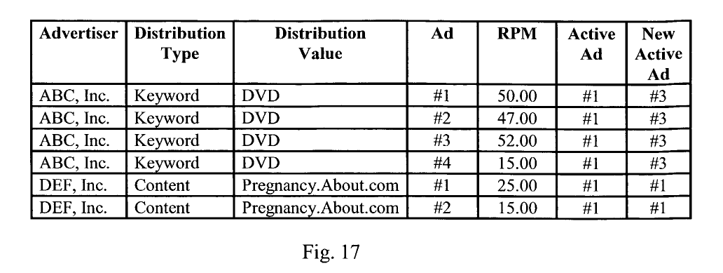

Also, as discussed above, the monitoring of RPM may also involve the selection of an active advertisement from a plurality of advertisements provided by an advertiser for a given bid. FIG. 17 depicts a table that indicates a determination that may be made by the advertiser listing provider system regarding multiple advertisements provided by a single advertiser for a given bid. Two examples are provided. In the first example, an advertiser ABC, Inc. has bid on the keyword “DVD” and provided four different advertisements. Over a given time period, the RPM is determined to be higher for Ad # 3 and therefore, Ad # 3 may be determined to be active ad that is displayed in the ranked listings for ABC's bid on the keyword DVD. To evaluate alternative ads, the four different ads may be run at different times, periods, etc. in an attempt to give each ad an opportunity to be viewed by a statistically significant number of viewers and in the relevant time periods. It is possible that alternative ads may not be used until the click-through rate for a given ad begins to decrease. Or, alternative ads may be displayed for a few hours each week with the active ad being used the rest of the week. In that way, alternative ads may be constantly supplied by the advertiser to see if the alternative ad is more effective than the current active ad, but without significant impact if it is substantially worse than the active ad. In other words, an incentive may be provided for the advertiser to try alternative ads that may generate more revenue and more traffic to the advertiser but without the potential penalty of losing ranking against competing advertisers. For example, the alternative advertisement click-through rate may be excluded from the overall advertisement rate when used for comparison against other bidders.

Similarly, the advertiser DEF, Inc. may have provided two advertisements for its bid on the content pages at pregnancy.about.com. After an evaluation period between the two advertisements, it may be determined that Ad # 1 was still the most effective based on RPM and therefore, may continue to be used as the active advertisement.

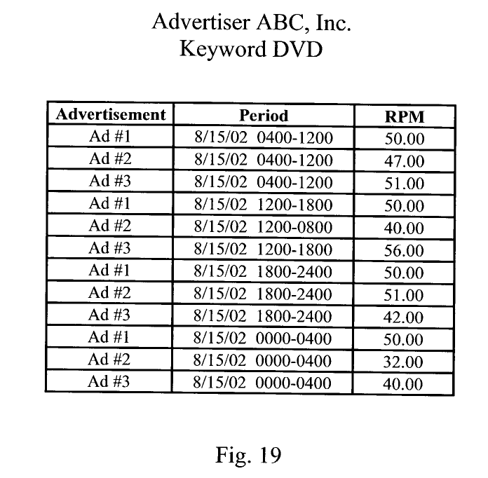

In addition, the comparison between multiple advertisements may be evaluated over different time periods to determine the highest RPM over different time periods. FIG. 19 depicts an example of a table that may represent the determination made by the advertising listing provider system in which different time periods within a single day are evaluated. As this example illustrates, it is possible for different advertisements to be more effective on a RPM basis at different times of the day. Accordingly, the advertisement selected for a bid may be based on RPM and selected time periods.

Other data may be factored into the evaluation to determine rankings based at least in part on revenue efficiency. Demographics of the audience, distribution channels, country, and other information that is available may be fed into the calculation to assist in maximizing the RPM for advertisements for bid-on keywords and content portal pages. For example, it may be determined that the ranking should generate different ranked listings for different distribution channels.

According to another embodiment, advertisements may be analyzed in groupings. The groupings may be based on the known result set expected by a particular distribution channel. Accordingly, the groupings may be analyzed separately for each distribution channel as well, with different distribution channels thus receiving a different order and listing of advertisements optimized to generate revenue through that channel. For example, one distribution channel may be a result set expected to be output for a content portal page. In such an embodiment, a set number of listings may be expected and the system of the present invention determines the most revenue-efficient combination of listings based on effective revenue per click for the grouping, varying the members of group over time to determine that most effective grouping. For explanation purposes, assume that there are only four Ads (A,B,C,D) for a given keyword (video games) of which only three listings are to be displayed on the feed (in this example the content portal page). In this example, advertiser B has provided two creatives, B1 and B2.

To decide the most efficient grouping, the system outputs each of the different combinations over a set period of time and determines the effective CPM Sum (cost to advertiser (and thus revenue to the advertisement distribution system) per thousand impressions) for each model. The various combinations are then: AB1C, AB1D, ACB1, ACD, ADB1, ADC, B1AC, B1AD, B1CA, B1CD, B1DA, B1DC, CB1A, CB1D, CAB1, CAD, CDB1, CDA, DB1C, DB1A, DCB1, DCA, DAB1, DAC, AB2C, AB2D, ACB2, ACD, ADB2, B2AC, B2AD, B2CA, B2CD, B2DA, B2DC, CB2A, CB2D, CAB2, CDB2, CDA, DB2C, DB2A, DCB2, DCA, and DAB2.

The Effective CPM Sum for each model may be calculated by summing the CPM (calculated by the equation 1000*Click-Through-Rate*CPC (cost per click)) of each listing.

If model CB1A yields this:

| Unit | CTR | CPC | ECPM |
|---|---|---|---|
| C | 0.00151 | .42 | .6342 |
| B1 | 0.00145 | .43 | .6235 |
| A | 0.00148 | .36 | .5328 |

Then the Effective CPM Sum is:

| | |
|---|---|
| CB1A | 1.7905 |

If model CB2A yields this:

| Unit | CTR | CPC | ECPM |
|---|---|---|---|
| C | 0.00151 | .42 | .6342 |
| B2 | 0.00149 | .43 | .6407 |
| A | 0.00148 | .36 | .5328 |

Then the Effective CPM Sum is:

| | |
|---|---|
| CB2A | 1.8077 |

This would indicate that CB2A is superior to CB1A.

Through this embodiment, ads are not compared to one another in isolation, but rather in the grouping that generates the most revenue. This embodiment recognizes that diversification of advertisements may generate more revenue due to the diverse interests of viewers. For example, a web page on a content portal related to video games may attract viewers that have many different game platforms. If all of the advertisements relate to sales of games only compatible with a single platform, the grouping may lack any advertisement of interest to the viewer.

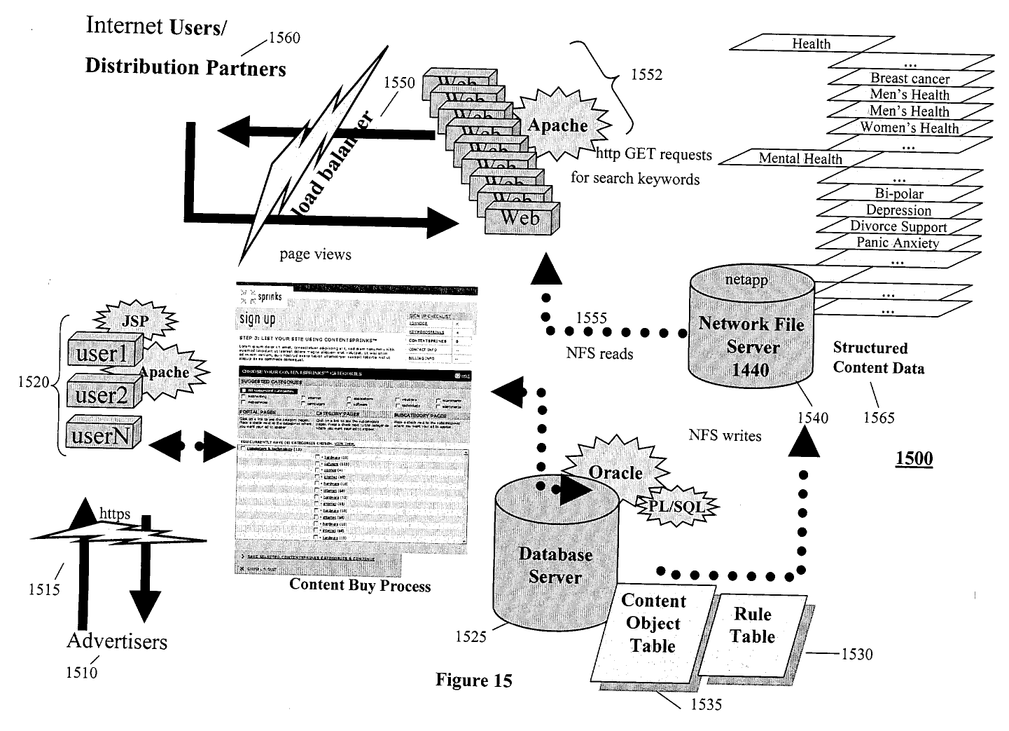

To enable advertisers to interact with the system, a web-based Internet system may be provided as shown in FIGS. 1 and 15, for example. In such an embodiment, Advertisement Providers 12 submit their advertisement listings to the Advertisement Listings Provider 16. It is understood that any number of Advertisement Providers 12 may submit advertisement listings to the Advertisement Listings Provider 16. Advertisement listings may include all or part of the following information fields: the name of the Advertisement Provider, a title of the advertisement, a description of the goods or services advertised, a URL to be displayed in the listing, a where an end user will be directed upon clicking on the advertisement, contact information, an email address, billing information, pricing information, and an advertisement identification number. In one embodiment of the present invention, the Advertising Listing Provider 16 ranks the advertisement listings submitted and stores the ranked listings in a Database Server 18. According to a specific embodiment, the rankings are generated based on an efficiency-based model as described above.

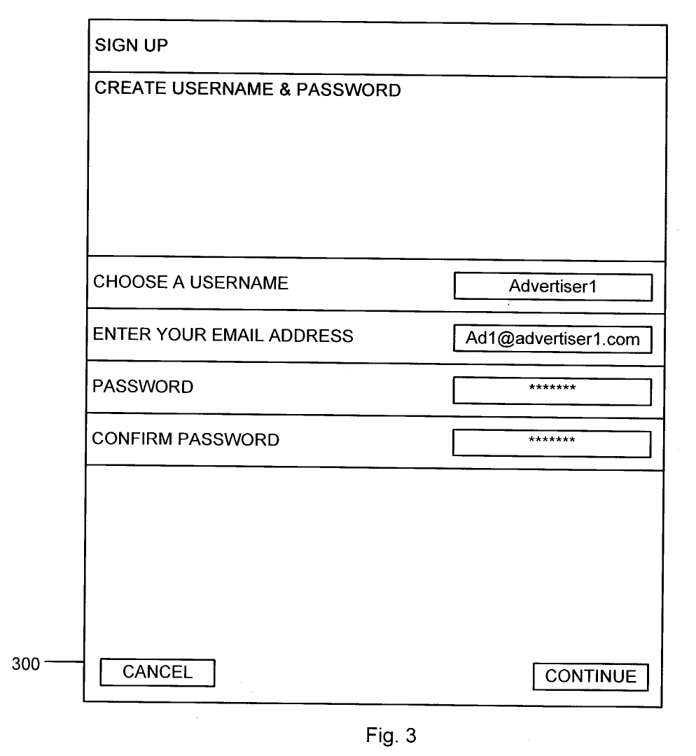

As discussed above, various embodiments of the present invention may be utilized in an advertising system based on content-based placement. An embodiment of a content-based placement system in which this efficiency-based ranking methodology may be utilized is described in a related patent application entitled “Method and System For Providing Advertising Through Content Specific Nodes Over the Internet,” Application No. 60/396,033 filed on Jul. 18, 2002. For completeness, a description of the operation of such a system is provided below, as modified to incorporate the provision of multiple advertisements by a single advertiser for the single-advertiser efficiency determination methodology as described above. This system is described in the context of FIGS. 3-15 below. It should be appreciated, however, that other systems for enabling input of advertisements may be used as well within the scope of the present invention.

FIG. 3 depicts a graphical user interface 300 that enables a user to “sign up” according to an embodiment of the present invention. A user desiring Internet advertising may access the system via a secured Internet connection. This embodiment depicts the process for a single user desiring Internet advertising to sign up, however, any number of users may access the system to purchase content node advertising. FIG. 3 shows the instigation of the process with the creation of a username and password to create a safe and secure system. There are other ways to accomplish the security aspect of the present invention, such as direct network connections, or subsequent verification by the user desiring Internet advertising.

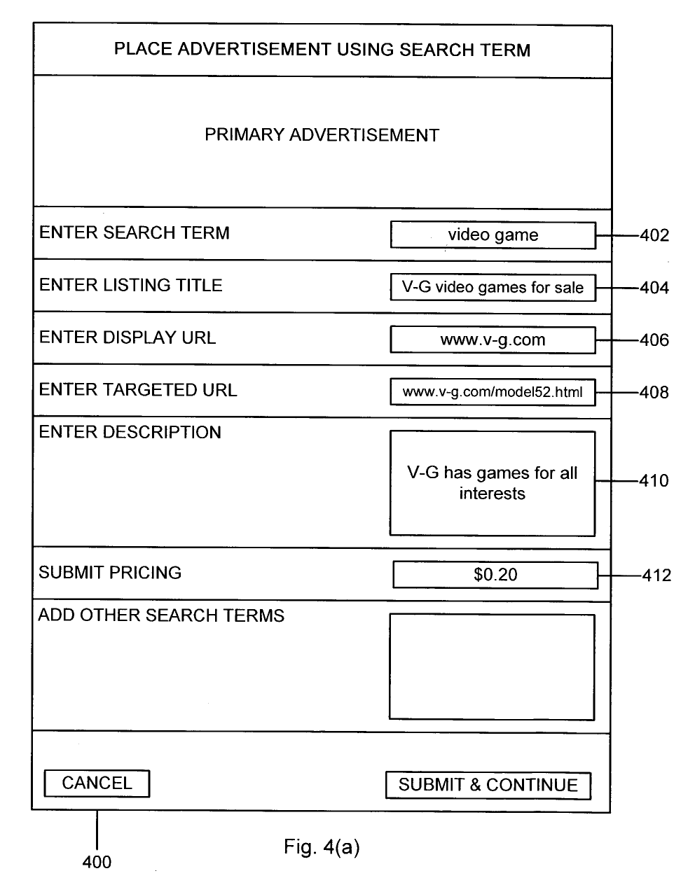

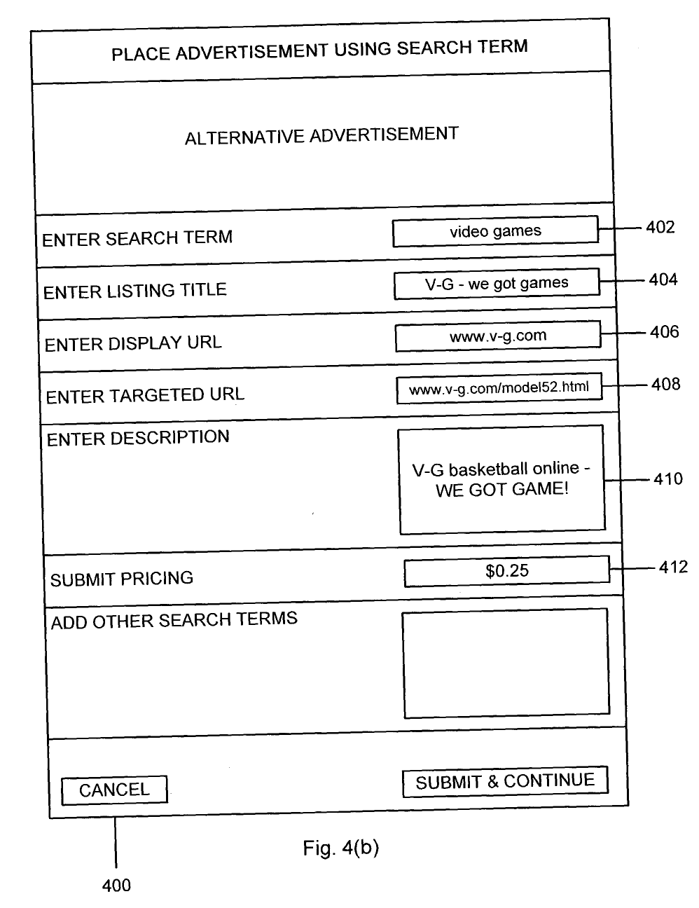

FIGS. 4(a)-(b) depict graphical user interface 400 that enables a user to list an advertisement on the Internet associated with a search term according to an embodiment of the present invention. As shown, a user may be provided with multiple graphical user interfaces, one each for each advertisement associated with a specific bid. It is also possible to provide a single graphical user interface to enable input of multiple advertisements corresponding to a bid. In one embodiment, the graphical user interface provides inputs for a general search term 402, representing the high level subject matter corresponding to the desired advertisement. Furthermore, the user desiring advertising may enter a listing title in input 404. The listing title represents the title the user desiring advertising wishes to display on the advertisement. For example, if the user desiring advertising wishes to sell video games breast pumps manufactured by a company under the name of “V-G” the listing title may be “V-G video games” or “V-G video games for sale” or other descriptive alternates. The user desiring advertising may also input a display URL in input 406, which may represent the location of the general website for the click through. For example, the V-G user may input a display URL of www.v-g.com. Additionally the user may input a targeted URL in input 408, which represents the actual URL of the site the end-user will be directed to if they click on the advertisement. This may be different from the display URL, for example, in that it directs the end-user to a particular model breast pump on sale (e.g., www.v-g.com\modeV52.html). Also, only a single URL may be input and the displayed URL may be the URL of the site to which the end-user may be directed by clicking on the advertisement. In this embodiment, the user desiring advertising may also input a description of the goods or services being advertised in input 410. Further, the user desiring advertising may submit a price in input 412. In an embodiment of the present invention, the pricing of the advertisements is accomplished via a bidding system. Each proposed advertisement listing has a bid price associated with it. In this embodiment, the listings are subsequently listed in descending order of bid prices for the specific level being displayed. The prices may be a per click through price or a flat rate, or as discussed above, a RPM ranking. The proposed listing end user may view the proposed listing in the proper order when the end user searches the web site for the search term or terms.

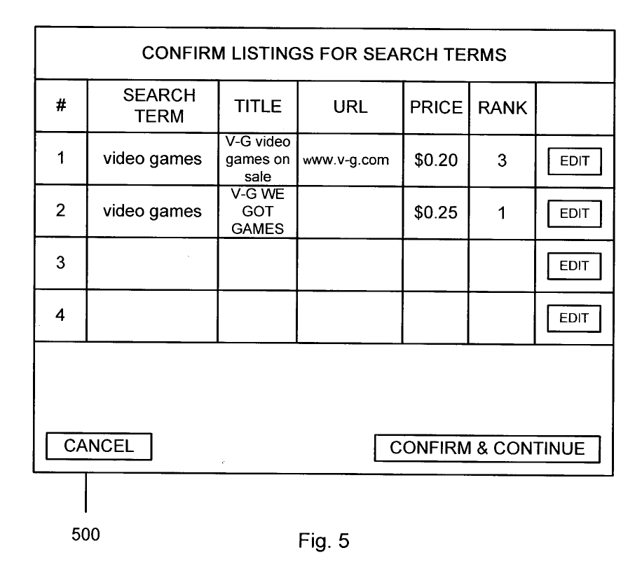

FIG. 5 depicts a graphical user interface 500 that enables a user to confirm listing an advertisement on the Internet associated with a search term according to an embodiment of the present invention. This graphical user interface allows the user desiring advertising to see what position their add would hold in the descending order of advertisements based upon the pricing previously submitted. In a RPM system, the ranking shown may be based on the price bid initially or may be based on the overall average click-through-times-bid amount, for example. If the user desiring advertising is not satisfied with the rank shown, or otherwise desires to adjust the rank of the listing, the user may accomplish this by choosing the edit button associated with that particular listing.

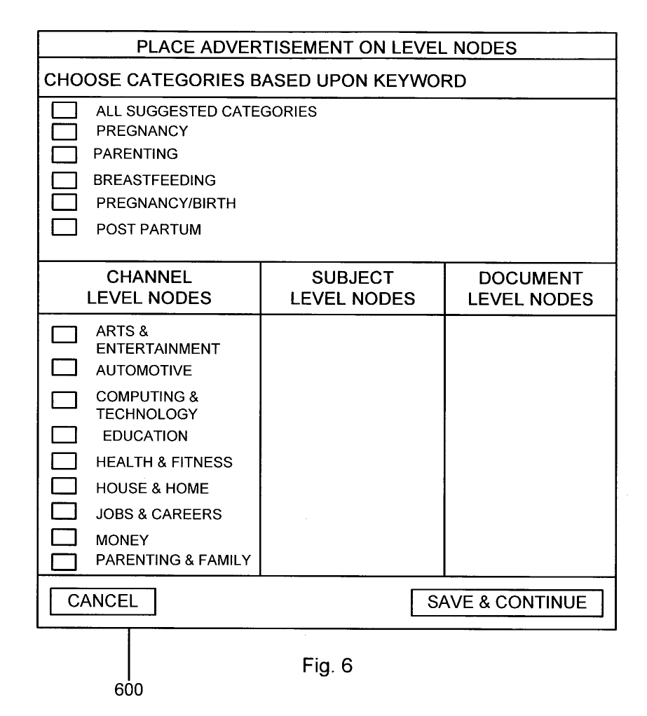

FIG. 6 depicts a graphical user interface 600 that enables a user to select a channel level node when listing an advertisement on level nodes according to an embodiment of the present invention. In this step the system may use the search terms previously entered to suggest document level nodes. This option may be accomplished under “Choose Categories Based Upon Keyword.” Also, the user desiring advertising may specify a category appropriate to the goods or services advertised under Channel Level Nodes. Changing example if the advertise were a breast pump manufacturer, the advertiser may select “Parenting and Family” as the Channel Level Node. The screenshot shows sample general subject matters. This list is not meant to be all inclusive. Any other subject matter topic may be appropriate.

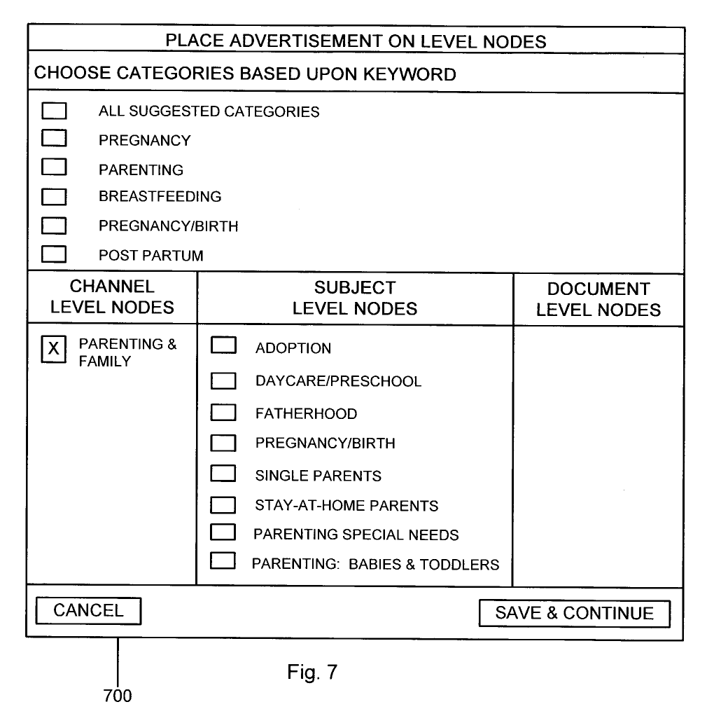

FIG. 7 depicts a graphical user interface 700 that enables an advertising user to select a subject level node when listing an advertisement on level nodes according to an embodiment of the present invention. In this graphical user interface, the system may use the search terms previously entered to again suggest document level nodes. This option may be accomplished under “Choose Categories Based Upon Keyword.” Also, the user desiring advertising may specify a category appropriate to the goods or services advertised under Subject Level Nodes. Continuing the example of the breast pump manufacturer desiring advertising, the user may select “Pregnancy/Birth” as the Subject Level Node. The graphical user interface of FIG. 7 provides an example of subject level nodes. This list is not meant to be inclusive. Any other subject matter topic may be appropriate and is preferably more specific than the subject matters listed as channel level nodes. The listing options that appear under the subject level nodes depend upon what selection the user desiring advertising made under the channel level node.

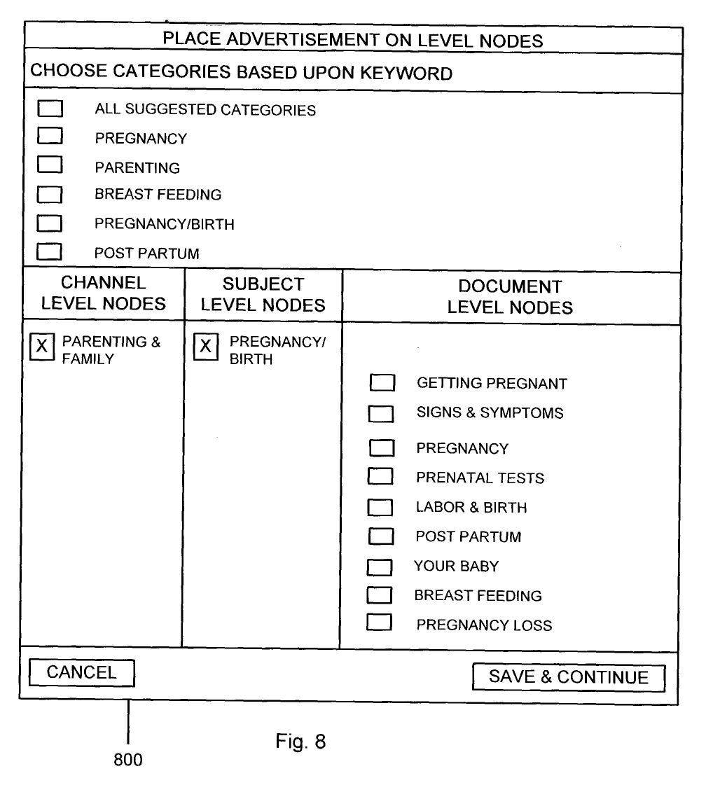

FIG. 8 depicts a graphical user interface 800 that enables a user to select a document level node when listing an advertisement on level nodes according to an embodiment of the present invention. In this graphical user interface, the system may use the search terms previously entered to suggest document level nodes. This option may be accomplished under “Choose Categories Based Upon Keyword.” Also, the advertisement provider user may specify a category appropriate to the goods or services advertised under Document Level Nodes. Continuing the example of the breast pump manufacturer desiring advertising, the user may select “Breastfeeding” as the Document Level Node. The graphical user interface 800 provides an example of general subject matter nodes. This list is not meant to be all inclusive. Any other subject matter topic may be appropriate, and preferably is more specific than the subject matters listed as subject level nodes. The listing options that appear under the document level nodes depend upon what selection the user desiring advertising made under the subject level node.

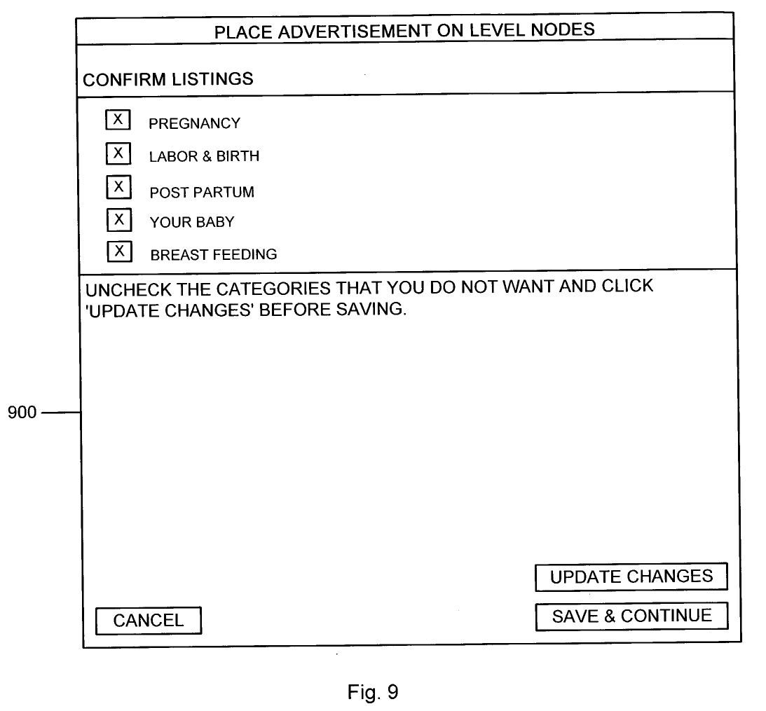

FIG. 9 depicts a graphical user interface 900 that enables an advertising provider user to confirm listings according to an embodiment of the present invention. If listings appear that the user desiring advertising does not wish to purchase, the user may so indicate such as, for example, by unchecking the corresponding box.

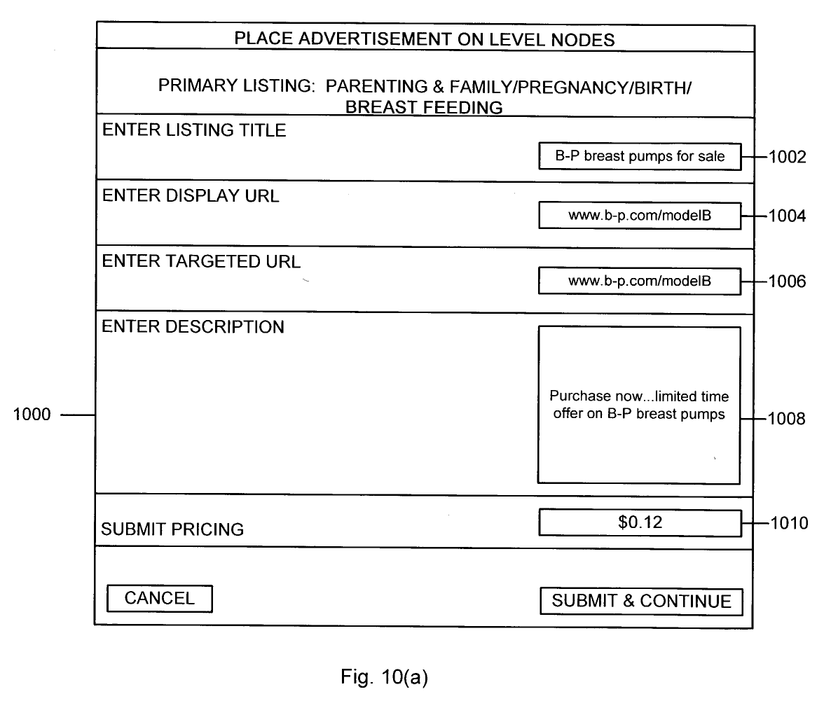

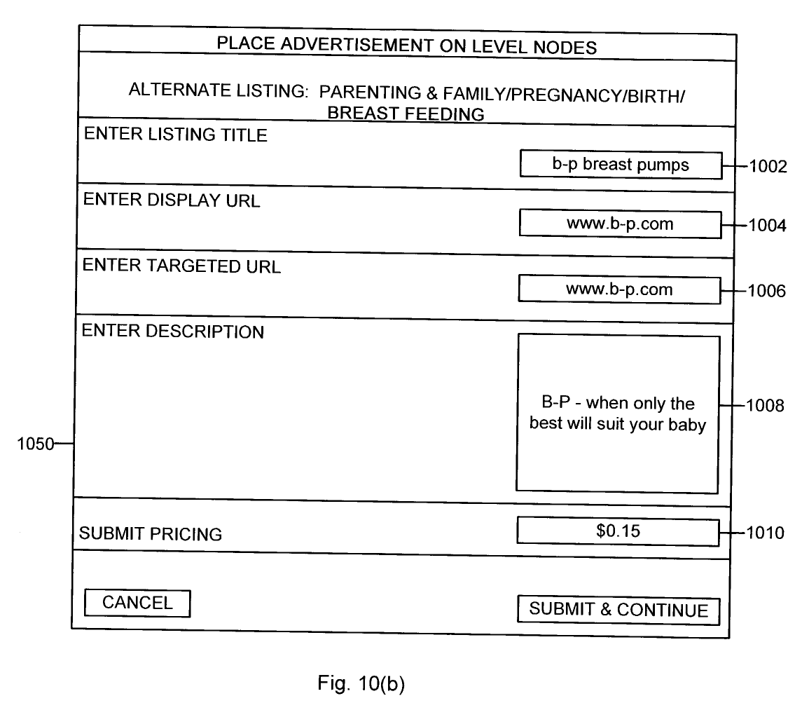

FIGS. 10(a) and (b) depicts graphical user interfaces 1000 and 1050 that enable a user to enter detailed listing information for various advertisements corresponding to the level-node content bid entered. In one embodiment, this step is individually accomplished for each desired document level node listing. For example, in FIGS. 10(a) and (b), two different alternative ads are provides, so the node-based ad is provided for each separate bid—one in graphical user interface 1000 and one in graphical user interface 1050. In one embodiment, the relational structure of the nodes chosen is represented in the listing name shown at the top of the graphical user interface 1000 and 1050. The user may then input a listing title, a display URL, a targeted URL, a description and a price in input areas 1002, 1004, 1006, 1008 and 1010, respectively.

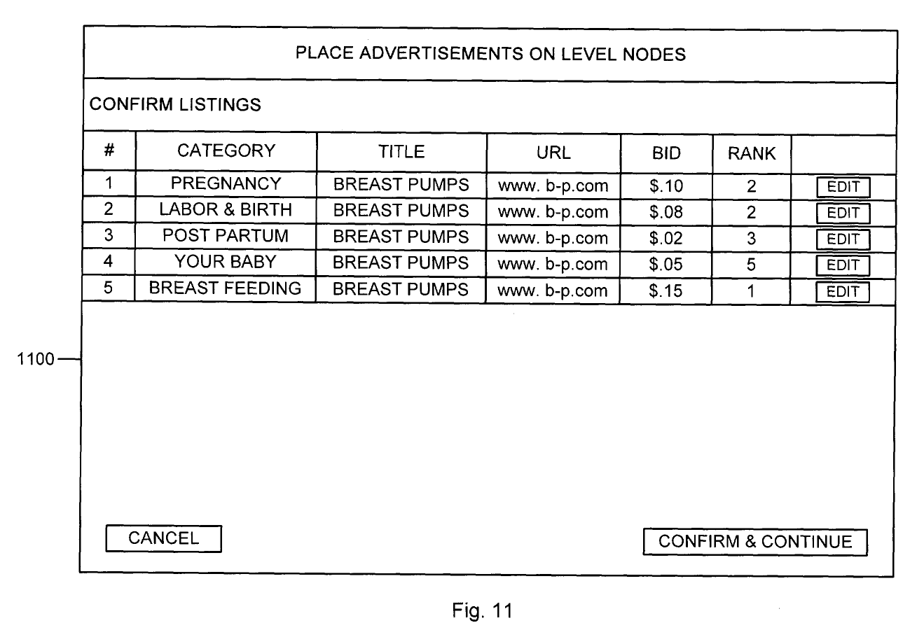

FIG. 11 depicts a graphical user interface 1100 that enables a user to confirm bids to list an advertisement on different level nodes within a given content portal according to an embodiment of the present invention. Once user has provided inputs in the GUI 1000/1050 for each desired document level node listing, the listings may be displayed in GUI 1100. Along with the information input by the user desiring advertising, the system may also display the rank the user would occupy with the price previously submitted for each listing. This GUI 1100 enables the advertiser to gauge its potential response by its ranking. For example, the breast pump manufacturer would likely be willing to pay more to be listed first on the breast feeding document level node, than on the pregnancy document level node. An end-user accessing documents related to breast feeding is more likely to be in the market for a breast pump than any given end-user accessing pregnancy, in the mind of the advertiser. Thus, the advertising user has bid more to achieve the first position in that breast feeding document level. If the user is not happy with the rank and bid amounts, the user may edit the listings.

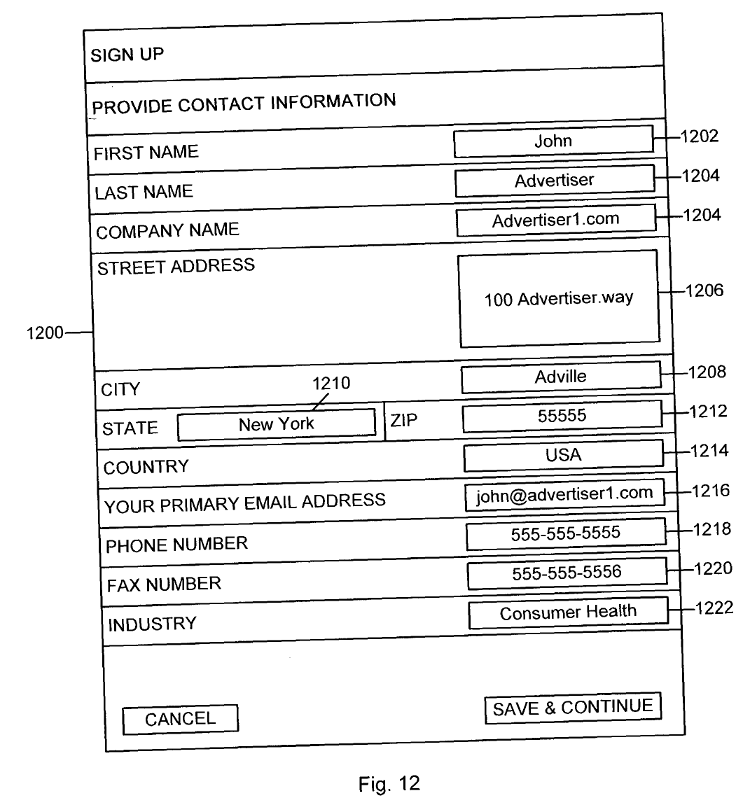

FIG. 12 depicts a graphical user interface 1200 that enables an advertising user to provide contact information according to an embodiment of the present invention. This contact information may include any or none of the following information relating to the user desiring advertising: first name, last name, company name, street address, city, state, zip code, country, email address, phone number, fax number, and industry through inputs 1202, 1204, 1206, 1208, 1210, 1212, 1214, 1216, 1218, 1220 and 1222, respectively. In other embodiments any number of other pieces of information regarding the user desiring advertising may be requested in this step.

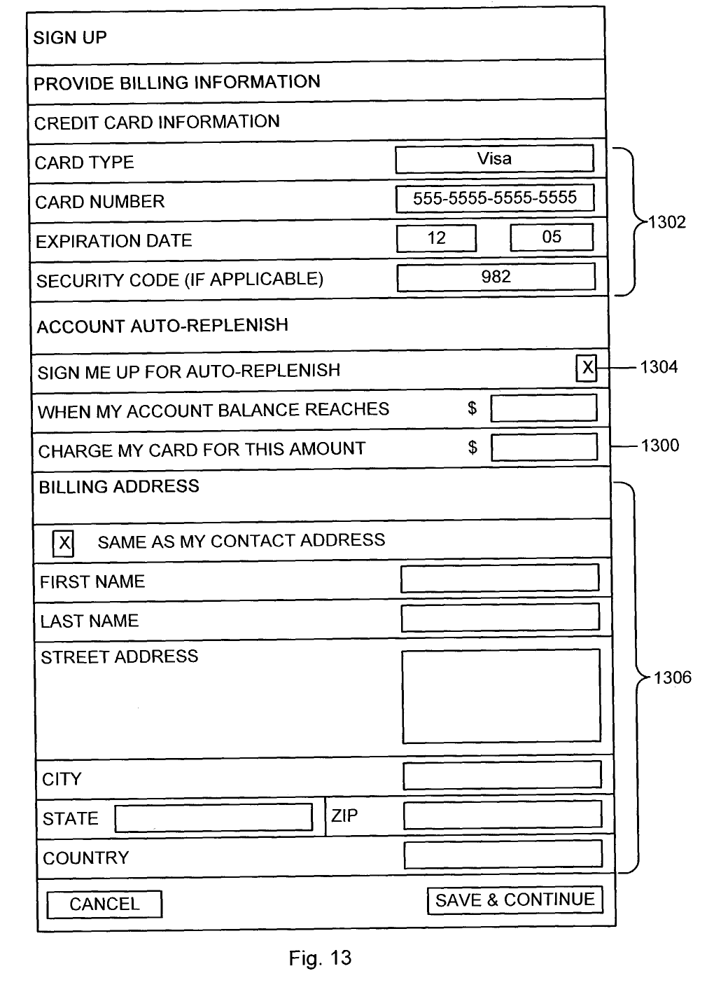

FIG. 13 depicts a graphical user interface 1300 that enables an advertising user to provide billing information according to an embodiment of the present invention. In one embodiment, the advertising user may enter a credit card or other financial account information that would enable automatic periodic billing by the system in input area 1302. In other embodiments, the system may periodically generate physical invoices, which are mailed to the advertiser. FIG. 13 shows an option where the user may choose to enable “account auto replenish” in input 1304. This feature allows the system to charge the user before any advertising expenses are actually incurred. The system charges a preset amount to the user's billing card whenever the user's account balance falls to a certain amount. In this step, the user may also input their billing address in input area 1306.

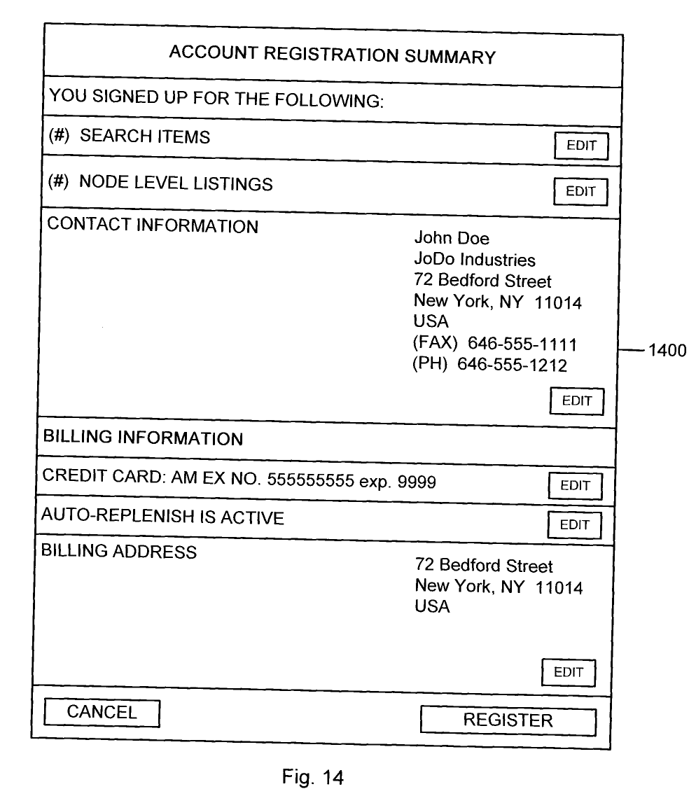

FIG. 14 depicts a graphical user interface 1400 that enables a user to register an account to list an advertisement on level nodes according to an embodiment of the present invention. This graphical user interface represents an opportunity to make changes to the listings, contact information, or billing information prior to the listing becoming live. Once the advertising user takes this step and registers the listings, the advertisements are then placed according to their node structure on the appropriate document level listings.

FIG. 15 is a schematic diagram representing an advertisement system 1500 whereby an advertiser is enabled to list ads on content specific pages according to varying levels of subject matter specificity, such as through the various embodiments depicted and described above. Multiple advertiser systems 1510 may connect to the Internet via an http connection 1515 and access the advertisement system through servers 1520. The http connection 1515 may be a secure one (https), if desired, although other security measures may also be utilized, such as described above. An advertiser system 1510 may access a database 1565 of content specificity via a database server 1525. Database server 1525 may provide software operations to interactively provide the graphical user interfaces presented in the example embodiments above, receive content from those graphical user interfaces, store the content into the database and then provide subsequent error messages, or appropriate confirmation messages. Database server 1525 may also sequence the pages to the user based on predetermined relationship(s) between the graphical user interface pages shown. One example of how this may be accomplished is through the database server reading and writing to a Content Object Table Database 1535 where advertisements associated with content may be stored. Furthermore, database server 1525 may enable the advertiser to read the Rule Table Database 1530, which may provide artificial system limitations regarding the listing of advertisements. These artificial system limitations may be rules designed to generate the highest profitability from a business standpoint. For example, based on the user's advertisement and subject matter, the system may recommend an advertising combination to maximize their advertising effectiveness. It should be appreciated that although a single network file server, database server, content object table and rule table are depicted in FIG. 15, multiple such object may be provided for purposes of scalability and optimization of the operations of this system.

When an advertiser system 1410 offers an amount for an ad listing, that offer may be stored in the Content Object Table Database 1435. Periodically, the Network File Server 1440 accesses the ads stored in the Content Object Table Database 1435 via the Database Server 1425 and writes them to the Structured Content Database 1465.

Additionally, multiple end users 1445 may connect via the Internet to various distribution partners to the multi-node hierarchical content-based system's content. For example, the multi-node hierarchical content-based system may be presented as a web site, such as the assignee of the present invention, About.com at www.about.com. Also, various partners of the host system may engage the host for purposes of providing some or all of the content on their web sites. For example, a web site about Women's issues may desire to distribute the subject level node(s) related to women's issues. The advertisements associated with those nodes may then be delivered along with the content for those nodes through the distribution partner to the end user over the Internet.

A load balancer 1450 may monitor the multiple Internet connections, including requests to the server from one or more distribution partners. Via web server(s) 1552, these multiple users may look for the content from the multi-node hierarchical content-based system. These multiple users 1445 may look for documents using the hierarchical node structure or by inputting search key words. In either case, the Network file server 1440 may read these requests 1455 and provide pages with related content along with the listings associated with that document. Thus the advertisement system illustrated in FIG. 15 enables an advertiser to offer an amount for ad placement on one content specific node, different from the amount offered for placement on another content specific node less likely to generate sales.

Once the advertisement system has accepted offers for placement of ads on a particular node, the advertisement system may publish those ads to the content specific node. For example, those ad listings may be published to a website, as mentioned above. For example, a document-level node may contain a single web page with informational content, links, graphics, chat, and other features related to the subject level, channel level and top level. Within that web page, some or all of the advertisers who placed ads for that level of specificity may be displayed. FIG. 18, as discussed above, provides one example of a single document-level node web page related to a document level node. That web page may be provided with the highest three bidders for that document-level, including the highest bidders for the higher-level nodes.

While the foregoing description includes details and specificities, it should be understood that such details and specificities have been included for the purposes of explanation only, and are not to be interpreted as limitations of the present invention. Many modifications to the embodiments described above can be made without departing from the spirit and scope of the invention, as it is intended to be encompassed by the following claims and their legal equivalents.

1. An advertisement distribution system for enabling advertisers to provide a hypertext link advertisement and an associated bid representing an amount the advertiser will pay upon selection by the hypertext link advertisement by an end user and rank advertisements provided by those advertisers based on revenue efficiency to the advertisement distribution system, the system comprising:
advertisement input receiving means for receiving at least one advertisement associated with a specific distribution subject and a bid representing an amount to be paid for click-throughs to the advertisement when the advertisement is distributed in association with the specific distribution subject;
advertisement listings output means for outputting a ranked listing of advertisement through one or more Internet distribution channels based on specific distribution subjects, the ranked listing comprising a plurality of advertisements received from the advertisement input receiving means and being based on an evaluation performed by an advertisement evaluation means;
advertisement evaluation means for evaluating the ranking of advertisements in the ranked listing for a specific distribution subject based on a revenue efficiency value of at least one advertisements in the ranked listing, the revenue efficiency value being based at least on a click-through rate for the at least one advertisement.

2. The advertisement distribution system of claim 1 wherein the advertisement evaluation means and advertisement listings output means generate a listing comprising an alternative advertisement for an individual advertiser.

3. The advertisement distribution system of claim 1 wherein the advertisement evaluation means and advertisement listings output means reorder the ranking of advertisements for a specific distribution subject.

4. The advertisement distribution system of claim 1 wherein the specific distribution subject comprises a keyword for distribution through a search engine.

5. The advertisement distribution system of claim 1 wherein the specific distribution subject comprises a subject within a content portal.

6. The advertisement distribution system of claim 5 wherein the specific distribution subject comprises a level node within a multi-level node content portal.

7. The advertisement distribution system of claim 1 wherein the advertisement evaluation means evaluates a grouping of advertisements based on the effective revenue efficiency of the grouping compared to other potential groupings of advertisements provided by advertisers for the specific distribution subject.

8. The advertisement distribution system of claim 7 wherein the advertisement evaluation means generates a ranking of listings as a grouping, the grouping comprising the ranked list of advertisements with the highest effective cost per thousand impressions.

9. The advertisement distribution system of claim 1 wherein the revenue efficiency value is calculated by multiplying the number of click-throughs over a predetermined number of impressions times the bid amount for the advertisement.

10. The advertisement distribution system of claim 1 wherein the revenue efficiency value is calculated by the click-through rate over a given period of time times the bid amount for the advertisement.

11. A method of distributing advertising based on a database of advertisements provided by advertisers that provide a hypertext link advertisement and an associated bid representing an amount the advertiser will pay upon selection by the hypertext link advertisement by an end user, the method of distributing advertising comprising the steps of:
receiving at least one advertisement associated with a specific distribution subject and a bid representing an amount to be paid for click-throughs to the advertisement when the advertisement is distributed in association with the specific distribution subject;
outputting a ranked listing of advertisement through one or more Internet distribution channels based on specific distribution subjects, the ranked listing comprising a plurality of advertisements received and being based on an evaluation step;
evaluating the ranking of advertisements in the ranked listing for a specific distribution subject based on a revenue efficiency value of at least one advertisements in the ranked listing, the revenue efficiency value being based at least on a click-through rate for the at least one advertisement.

12. The method of claim 11 further comprising the step of generating a listing comprising an alternative advertisement for an individual advertiser.

13. The method of claim 11 further comprising the step of reordering the ranking of advertisements for a specific distribution subject.

14. The method of claim 11 wherein the specific distribution subject comprises a keyword for distribution through a search engine.

15. The method of claim 11 wherein the specific distribution subject comprises a subject within a content portal.

16. The method of claim 15 wherein the specific distribution subject comprises a level node within a multi-level node content portal.

17. The method of claim 11 wherein the evaluating step comprises evaluating a grouping of advertisements based on the effective revenue efficiency of the grouping compared to other potential groupings of advertisements provided by advertisers for the specific distribution subject.

18. The method of claim 17 wherein the listing of advertisements generated comprises a grouping that comprises the ranked list of advertisements with the highest effective cost per thousand impressions.

19. The method of claim 11 wherein the revenue efficiency value is calculated by multiplying the number of click-throughs over a predetermined number of impressions times the bid amount for the advertisement.

20. The method of claim 11 wherein the revenue efficiency value is calculated by the click-through rate over a given period of time times the bid amount for the advertisement.

21. An advertisement distribution system for enabling advertisers to provide a hypertext link advertisement and an associated bid representing an amount the advertiser will pay upon selection by the hypertext link advertisement by an end user and rank advertisements provided by those advertisers based on revenue efficiency to the advertisement distribution system, the system comprising:
an advertisement input receiving module that receives at least one advertisement associated with a specific distribution subject and a bid representing an amount to be paid for click-throughs to the advertisement when the advertisement is distributed in association with the specific distribution subject;
an advertisement listings output module that outputs a ranked listing of advertisement through one or more Internet distribution channels based on specific distribution subjects, the ranked listing comprising a plurality of advertisements received from the advertisement input receiving means and being based on an evaluation performed by an advertisement evaluation system;
an advertisement evaluation system that evaluates a ranking of advertisements in the ranked listing for a specific distribution subject based on a revenue efficiency value of at least one advertisements in the ranked listing, the revenue efficiency value being based at least on a click-through rate for the at least one advertisement.

22. The advertisement distribution system of claim 21 wherein the listing generated includes an alternative advertisement for an individual advertiser.

23. The advertisement distribution system of claim 21 wherein the listing generated includes a re-ordering of the ranking of advertisements for a specific distribution subject.

24. The advertisement distribution system of claim 21 wherein the specific distribution subject comprises a keyword for distribution through a search engine.

25. The advertisement distribution system of claim 21 wherein the specific distribution subject comprises a subject within a content portal.

26. The advertisement distribution system of claim 25 wherein the specific distribution subject comprises a level node within a multi-level node content portal.

27. The advertisement distribution system of claim 21 wherein the advertisement evaluation system evaluates a grouping of advertisements based on the effective revenue efficiency of the grouping compared to other potential groupings of advertisements provided by advertisers for the specific distribution subject.

28. The advertisement distribution system of claim 27 wherein the advertisement evaluation system generates a ranking of listings as a grouping, the grouping comprising the ranked list of advertisements with the highest effective cost per thousand impressions.

29. The advertisement distribution system of claim 21 wherein the revenue efficiency value is calculated by multiplying the number of click-throughs over a predetermined number of impressions times the bid amount for the advertisement.

30. The advertisement distribution system of claim 21 wherein the revenue efficiency value is calculated by the click-through rate over a given period of time times the bid amount for the advertisement.
